(19) United States
(12) Patent Application Publication
(10) Pub. No.: US 2014/0307562 A1
(43) Pub. Date: Oct. 16, 2014

(54) PACKET LOSS COUNTER

(71) Applicant: IPLIGHT LTD., Petach Tikva (IL)

(72) Inventor: Leon Bruckman, Petah-Tikva (IL)

(73) Assignee: IPLIGHT LTD., Petach Tikva (IL)

(21) Appl. No.: 13/860,551

(22) Filed: Apr. 11, 2013

(51) Int. Cl. H04L 12/26

(52) U.S. Cl. CPC H04L 43/0835
USPC 370/241.1

(57) ABSTRACT

A method for communication includes generating in a transmitter a sequence of data packets for transmission to a receiver. Control packets are inserted into the sequence in the transmitter, such that a given control packet is indicative of a count of the data packets that are transmitted in a time interval that ends with a previous control packet that precedes the given control packet. The sequence, including the data packets and the inserted control packets, is transmitted to the receiver.

### FIELD OF THE INVENTION

The present invention relates generally to packet communication, and particularly to methods and systems for assessing packet loss.

### BACKGROUND OF THE INVENTION

Packet networks use various kinds of Operations, Administration and Maintenance (OAM) tools in order to manage the network. Some OAM tools involve performance measurements, such as monitoring of packet loss. For example, OAM for Ethernet™ networks is addressed by the International Telecommunication Union (ITU) in Recommendation ITU-T G.8013/Y.1731, entitled “OAM Functions and Mechanisms for Ethernet Based Networks,” which is incorporated herein by reference. Section 8 of this recommendation addresses performance monitoring, including frame loss measurement (ETH-LM).

### SUMMARY OF THE INVENTION

An embodiment of the present invention that is described herein provides a method for communication. The method includes generating in a transmitter a sequence of data packets for transmission to a receiver. Control packets are inserted into the sequence in the transmitter, such that a given control packet is indicative of a count of the data packets that are transmitted in a time interval that ends with a previous control packet that precedes the given control packet. The sequence, including the data packets and the inserted control packets, is transmitted to the receiver.

In some embodiments, generating the sequence includes incrementing a transmit packet counter for each generated data packet, and inserting the control packets includes reading the transmit packet counter at an end of the previous time interval, and formatting the given control packet based on the read transmit packet counter. In an embodiment, reading of the transmit packet counter and formatting of the given control packet are carried out by software running in the transmitter.

In some embodiments the method includes receiving the sequence at the receiver, and measuring a mismatch in packet count between the transmitter and the receiver using the control packets. In an example embodiment, receiving the sequence includes incrementing a receive packet counter for each received data packet, and measuring the mismatch includes reading the receive packet counter at an end of the previous time interval, and comparing the count indicated in the given control packet with the read receive packet counter. In another embodiment, detecting the mismatch includes measuring a packet loss ratio associated with a connection between the transmitter and the receiver.

In some embodiment, the method includes detecting a loss of one or more of the control packets, and taking a corrective action that prevents the loss of the control packets from affecting detection of the mismatch. In a disclosed embodiment, inserting the control packets includes adding to the control packets respective sequence numbers by the transmitter, and detecting the loss of the control packets includes detecting a gap in the sequence numbers of the control packets received by the receiver.

In another embodiment, detecting the loss of the control packets includes detecting that no control packet is received in a predefined time window around an expected control packet arrival time. In an embodiment, taking the corrective action includes discarding the measured mismatch for at least two time intervals. In an alternative embodiment, taking the corrective action includes delaying a notification of the loss by at least two time intervals.

There is additionally provided, in accordance with an embodiment of the present invention, a communication apparatus including transmission circuitry and a transmission controller. The transmission circuitry is configured to generate a sequence of data packets and to transmit the sequence. The transmission controller is configured to produce and insert into the transmitted sequence control packets, such that a given control packet is indicative of a count of the data packets that are transmitted in a time interval that ends with a previous control packet that precedes the given control packet.

There is also provided, in accordance with an embodiment of the present invention, a communication system including a transmitter and a receiver. The transmitter is configured to generate a sequence of data packets, to insert control packets into the sequence, such that a given control packet is indicative of a count of the data packets that are transmitted in a time interval that ends with a previous control packet that precedes the given control packet, and to transmit the sequence, including the data packets and the inserted control packets. The receiver is configured to receive the sequence from the transmitter, and to measure a mismatch in packet count between the transmitter and the receiver using the control packets.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a transmit node and a receive node that carry out packet loss measurement, in accordance with an embodiment of the present invention;

FIG. 2 is a diagram that schematically illustrates a flow of data packets and control packets for measuring packet loss, in accordance with an embodiment of the present invention; and

FIGS. 3 and 4 are flow charts that schematically illustrate transmitter-side and receiver-side packet loss measurement processing, respectively, in accordance with an embodiment of the present invention.

### DETAILED DESCRIPTION OF EMBODIMENTS

### Overview

Embodiments of the present invention that are described herein provide improved methods and systems for measuring packet loss on a communication connection between a transmitter and a receiver. These methods and systems can be used, for example, for measuring the Packet Loss Rate (PLR) or otherwise assessing the Quality of Service (QoS) on the connection.

In the disclosed embodiments, the transmitter generates a sequence of data packets and sends them to the receiver. In order to measure packet loss, the transmitter occasionally inserts control packets into the transmitted packet sequence. The control packets carry counter values that track the number of transmitted data packets. The receiver detects and measures packet loss by comparing the counter values extracted from the control packets to actual counts of received packets.

The description that follows refers mainly to packet loss, for the sake of clarity. Generally, however, the disclosed techniques also detect erroneous addition of packets to the sequence. In the context of the present patent application and in the claims, loss or gain of at least one packet is referred to as a mismatch in packet count between the transmitter and the receiver. The disclosed techniques are able to measure both types of mismatch.

The control packets essentially divide the sequence into time intervals, each interval comprising multiple data packets. In some embodiments, the transmitter sets the counter value in a given control packet to indicate the count of transmitted data packets in some past time interval, not the time interval that ends with the given control packet. For example, the n^{th} control packet may indicate the count of transmitted data packets in the time interval that ends with the (n−1)^{th} control packet. The receiver, being aware of the time lag in the counter values, compares each counter value with the actual count of received packets in the appropriate time interval.

It is possible in principle for each control packet to indicate the count of transmitted data packets in the time interval that immediately precedes the control packet. This sort of solution, however, means that the transmitter must produce the control packet and set its counter value within a very short time. This requirement imposes extreme timing constraints in the transmitter, which typically mandates hardware-only implementation.

When using the disclosed techniques, on the other hand, the above-described timing constraints are relaxed considerably. Since the counter value in each control packet indicates the packet count in an earlier time interval, the transmitter has considerably more time to produce the control packet and set the counter value. As a result, this task can be performed in software, e.g., by a host controller.

The disclosed solution is particularly suitable for communication connections that carry hierarchical traffic, such as multiple Virtual Local Area Networks (VLAN) or multiple Medium Access Control (MAC) layers (sometimes denoted “MAC-in-MAC”). In such schemes, the task of inserting the control packet is relatively complex, and the relaxed timing offered by the disclosed technique is therefore very valuable.

Another advantage is in the presence of high-priority packets that cannot be delayed but should nevertheless be counted correctly. The disclosed techniques also enable high flexibility and straightforward adaptation to changes in the communication protocol being used. All these benefits are achieved without degradation of packet loss measurement accuracy.

Several example implementations of the disclosed techniques are described in detail below. Additional measures for mitigating possible loss of control packets are also described.

### System Description

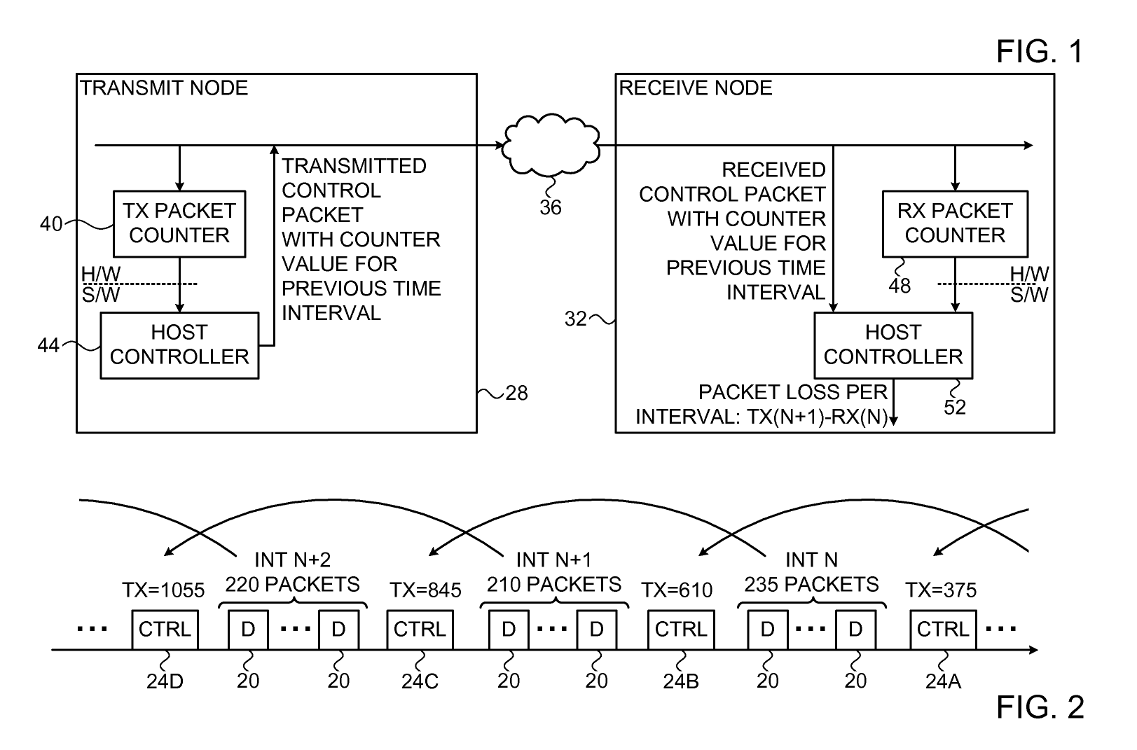

FIG. 1 is a block diagram that schematically illustrates communication system, comprising a transmit node 28 and a receive node 32 that carry out packet loss measurement, in accordance with an embodiment of the present invention. Each of nodes 28 and 32 may comprise, for example, a network element, a Network Interface Card (NIC) or any other suitable kind of communication node. Nodes 28 and 32 may communicate in accordance with various packet communication protocols, for example Ethernet, Asynchronous Transfer Mode (ATM) or any other suitable protocol.

Transmit node 28 sends a sequence of data packets to receive node 32 over a connection that traverses a communication network 36. The example of FIG. 1 shows a unidirectional connection for the sake of clarity. In many practical scenarios the connection is bidirectional, in which case each node serves as a transmit node for one direction of the connection and as a receive node for the opposite direction.

Transmit node 28 comprises transmission circuitry (not shown in the figure) that generates a sequence of data packets and transmits the sequence to receive node 32. The transmit node further comprises a TX packet counter 40, which counts the transmitted packets. Typically, counter 40 is incremented for each transmitted packet, irrespective of the packet type or other attributes. In an Ethernet implementation, for example, counter 40 is incremented for each transmitted Ethernet frame, independently of higher protocol layers. Counter 40 and its control circuitry are typically implemented in hardware or firmware, so as to support high packet rates.

Transmit node 28 comprises a host controller 44. Among other tasks, controller 44 produces control packets and inserts them into the sequence of data packets transmitted to receive node 32. In an embodiment, controller 44 inserts a control packet approximately every 100 mSec, although any other suitable values can also be used. The control packets thus divide the packet sequence into time intervals. The number of data packets in each interval may vary.

Each control packet carries a counter value that tracks the count of transmitted packets. In some embodiments, controller 44 sets the counter value of each control packet to indicate the number of data packets transmitted during a previous time interval (a time interval that ends with some previous control packet, not the presently-inserted control packet). This mechanism is demonstrated in FIG. 2 below.

Receive node 32 comprises a RX packet counter 48, which counts the received packets. Counter 48 is typically incremented for each received packet, irrespective of the packet type or other attributes. Counter 48 and its control circuitry are typically implemented in hardware or firmware.

The receive node further comprises a host controller 52. Among other tasks, controller 52 reads counter 48, extracts the counter values from the received control packets, and measures packet loss by comparing the counts of the transmitted data packets (extracted from the control packets) with the respective counts of the actually received data packets (according to RX packet counter 48).

Since each control packet indicates the count of data packets for a past time interval, host controller 52 typically compares the count of the transmitted packets and the count of the received packets with an offset. For example, when the (n+1)^{th} control packet indicates the count of transmitted data packets in the time interval that ends with the n^{th} control packet, host controller 52 compares the (n+1)ₜₕ control packet counter value (denoted TX(N+1)) with the RX packet counter for the n^{th} time interval (denoted RX(N)).

A positive value of TX(N+1)−RX(N) indicates that one or more packets were lost between the transmit node and the receive node. A negative value of TX(N+1)−RX(N) indicates that one or more packets were erroneously added between the transmit node and the receive node. The absolute value of TX(N+1)−RX(N) gives the number of lost or added packets.

The system and node configurations shown in FIG. 1 are example configurations, which are chosen purely for the sake of conceptual clarity. In alternative embodiments, any other suitable system and/or node configurations can be used. For example, in a bidirectional connection, each endpoint of the node carries out the functions of both the transmit node and the receive node, and the functions of host controllers and 52 are typically implemented in a single controller.

As another example, in the example of FIG. 1 the n^{th} control packet indicates the count of transmitted data packets in the time interval that ends with the (n−1)^{th} control packet. In alternative embodiments, the n^{th} control packet may indicate the count of transmitted data packets in an earlier time interval, e.g., the interval that ends with the (n−k)^{th} control packet, k≧2.

Certain elements of nodes 28 and 32 may be implemented using hardware/firmware, such as using one or more Application-Specific Integrated Circuits (ASICs) or Field-Programmable Gate Arrays (FPGAs). Alternatively, some node elements may be implemented in software or using a combination of hardware/firmware and software elements. FIG. 1 shows an example partitioning of each node into hardware (H/W) and software (S/W) modules, but any other suitable partitioning may be used in alternative embodiments.

In some embodiments, certain node functions, such as certain functions of host controller 44 and/or host controller 52, may be implemented using a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Example Packet Sequence with Inserted Control Packets

FIG. 2 is a diagram that schematically illustrates a flow of data packets 20 and control packets 24 sent from transmit node 28 to receive node 32, in accordance with an embodiment of the present invention. The figure shows a portion of the sequence, in which four successive control packets 24A . . . 24D divide the sequence into intervals numbered N, N+1 and N+2. (Interval N precedes interval N+1 in time, and interval N+1 precedes interval N+2.)

Each interval comprises multiple data packets 20. In the present example, interval N comprises 235 data packets, interval N+1 comprises 210 data packets, and interval N+2 comprises 220 data packets.

Each control packet carries a counter value denoted TX, which reflects the count of transmitted data packets in the interval that ends with the previous control packet. In the present example, the counter value in each control packet is higher than the counter value of the previous control packet by this count.

For example, control packet 24C carries a counter value of TX=845. This value, which is higher by 235 than the counter value of control packet 24B (TX=610), indicates that interval N comprises 235 transmitted packets. Similarly, control packet 24D carries a counter value of TX=1055 (=845+210), indicating that interval N+1 comprises 210 data packets.

As can be seen in the figure, each control packet does not indicate the number of transmitted data packets in the interval that immediately precedes the control packet, but rather one interval before. This convention allows host controller 44 an entire time interval (e.g., on the order of 100 mSec) to read TX packet counter 40 and generate and insert the control packet with the correct counter value. In alternative embodiments, it is possible to increase this time as needed by having each control packet indicate the count of transmitted data packets in an even earlier interval.

### Transmitter-Side and Receiver-Side Method Descriptions

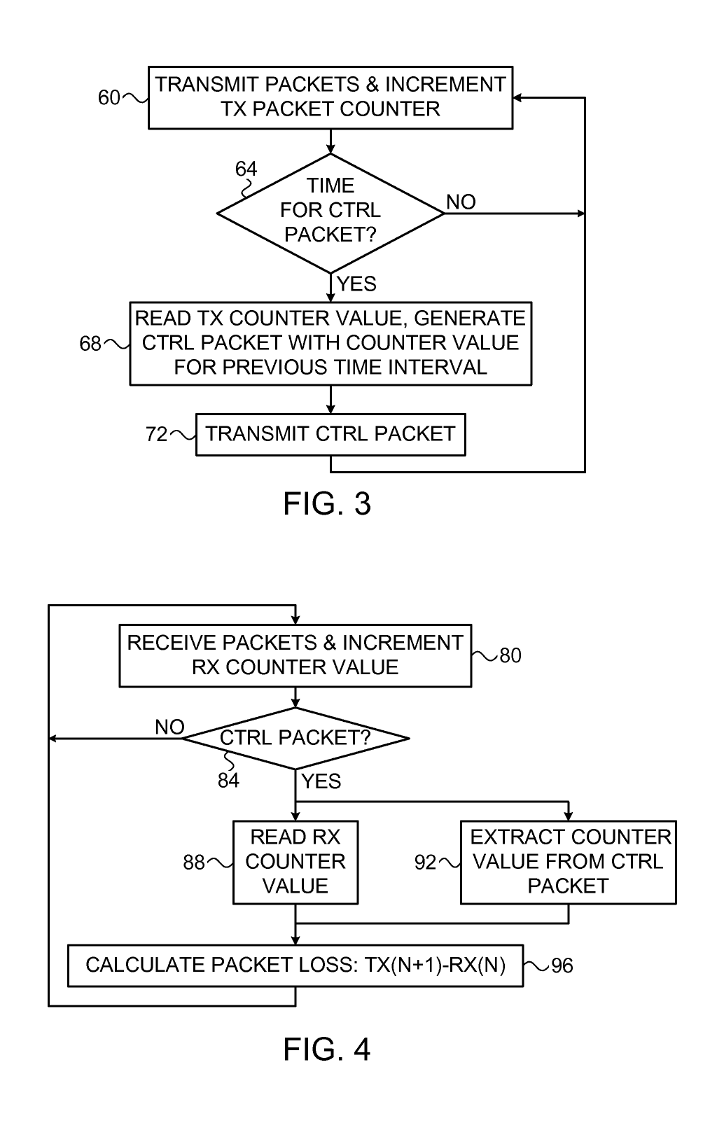

FIG. 3 is a flow chart that schematically illustrates the transmit-node side of the above-described process, in accordance with an embodiment of the present invention. The method begins with transmit node 28 transmitting data packets to receive node 32, at a data transmission step 60. For each transmitted packet, the transmit node increments TX packet counter 40.

Host controller 44 checks whether it is time to start preparing the next control packet, at a control packet checking step 64. If not, the method loops back to step 60. Typically, host controller 44 begins to prepare the next control packet in response to receiving a notification (e.g., interrupt) from the transmit node circuitry that the previous control packet has been sent.

In response to this notification, controller 44 generates a control packet, at a control generation step 68. Controller 44 reads TX counter value 60 at the time the previous control packet was actually transmitted, and generates the next control packet with this counter value. The host controller then inserts the new control packet into the packet sequence, at a control transmission step 72. The method then loops back to step 60 above.

FIG. 4 is a flow chart that schematically illustrates the receive-node side of the above-described process, in accordance with an embodiment of the present invention. The method begins with receive node 32 receiving the sequence of packets, at a reception step 80. For each received packet, the receive node increments RX packet counter 48.

For each received packet, the receive node circuitry checks whether this packet is a control packet, at a control checking step 84. If not, the method loops back to step 80. When detecting a control packet, host controller 52 reads RX packet counter 48 (RX(N), at an RX counter readout step 88, and extracts the TX counter value (TX(N+1)) from the received control packet, at an extraction step 92. Host controller 52 then calculates the packet loss, at a loss estimation step 96, e.g., by calculating TX(N+1)−RX(N). The method then loops back to step 80.

### Recovery from Loss of Control Packets

When using the packet loss measurement methods described above, receive node 32 may err if one or more control packets are lost. In some embodiments, host controller 52 in the receive node uses a mechanism for detecting and recovering from loss of control packets.

In an example embodiment, the transmit node adds sequence numbers to the generated control packets. The receive node extracts the sequence numbers from the received control packets. A gap in the sequence numbers indicates to the receive node that a control packet was lost. In response to detecting such a loss, the receive node may discard the measurements in the two time intervals that follow.

In other embodiments, the receive node is aware of the nominal rate of the control packets, and therefore of the expected arrival time of the next control packet. If no control packet is received in a certain time window around the expected arrival time of the next control packet, the receive node may conclude that a control packet was lost. As in the previous example, the receive node may respond by discarding the measurements in the two time intervals that follow.

Yet another possibility is for the receive node to delay the packet loss indication by at least two time intervals. If a control packet is lost, then the next received control packet will typically indicate (erroneously) loss of several data packets (large positive value for TX(N+1)−RX(N)). The subsequently-received control packet, however, will typically indicate addition of a similar number of data packets (large negative value for TX(N+1)−RX(N)). These two numbers cancel each other. Therefore, delaying the control packet loss indication by two intervals will overcome the loss of a single control packet.

In alternative embodiments, host controller 52 may use any other suitable mechanism for detecting and mitigating loss of control packets.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for communication, comprising:
in a transmitter, generating a sequence of data packets for transmission to a receiver;
inserting in the transmitter control packets into the sequence, such that a given control packet is indicative of a count of the data packets that are transmitted in a time interval that ends with a previous control packet that precedes the given control packet; and
transmitting the sequence, including the data packets and the inserted control packets, to the receiver.

2. The method according to claim 1, wherein generating the sequence comprises incrementing a transmit packet counter for each generated data packet, and wherein inserting the control packets comprises reading the transmit packet counter at an end of the previous time interval, and formatting the given control packet based on the read transmit packet counter.

3. The method according to claim 2, wherein reading of the transmit packet counter and formatting of the given control packet are carried out by software running in the transmitter.

4. The method according to claim 1, and comprising receiving the sequence at the receiver, and measuring a mismatch in packet count between the transmitter and the receiver using the control packets.

5. The method according to claim 4, wherein receiving the sequence comprises incrementing a receive packet counter for each received data packet, and wherein measuring the mismatch comprises reading the receive packet counter at an end of the previous time interval, and comparing the count indicated in the given control packet with the read receive packet counter.

6. The method according to claim 4, wherein detecting the mismatch comprises measuring a packet loss ratio associated with a connection between the transmitter and the receiver.

7. The method according to claim 4, and comprising detecting a loss of one or more of the control packets, and taking a corrective action that prevents the loss of the control packets from affecting detection of the mismatch.

8. The method according to claim 7, wherein inserting the control packets comprises adding to the control packets respective sequence numbers by the transmitter, and wherein detecting the loss of the control packets comprises detecting a gap in the sequence numbers of the control packets received by the receiver.

9. The method according to claim 7, wherein detecting the loss of the control packets comprises detecting that no control packet is received in a predefined time window around an expected control packet arrival time.

10. The method according to claim 7, wherein taking the corrective action comprises discarding the measured mismatch for at least two time intervals.

11. The method according to claim 7, wherein taking the corrective action comprises delaying a notification of the loss by at least two time intervals.

12. A communication apparatus, comprising:
transmission circuitry, which is configured to generate a sequence of data packets and to transmit the sequence; and
a transmission controller, which is configured to produce and insert into the transmitted sequence control packets, such that a given control packet is indicative of a count of the data packets that are transmitted in a time interval that ends with a previous control packet that precedes the given control packet.

13. The apparatus according to claim 12, wherein the transmission circuitry comprises a transmit packet counter and is configured to increment the transmit packet counter for each generated data packet, and wherein the transmission controller is configured to read the transmit packet counter at an end of the previous time interval and to format the given control packet based on the read transmit packet counter.

14. The apparatus according to claim 13, wherein the transmission controller is configured to run software that reads the transmit packet counter and formats the given control packet.

15. The apparatus according to claim 12, and comprising a receiver, comprising:
reception circuitry, which is configured to receive the sequence; and
a reception controller, which is configured to measure a mismatch in packet count between the transmission controller and the reception controller using the control packets.

16. The apparatus according to claim 15, wherein the reception circuitry comprises a receive packet counter and is configured to increment the transmit packet counter for each received data packet, and wherein the reception controller is configured to read the receive packet counter at an end of the previous time interval and to detect the mismatch by comparing the count indicated in the given control packet with the read receive packet counter.

17. The apparatus according to claim 15, wherein, by detecting the mismatch, the reception controller is configured to measure a packet loss ratio associated with a connection between the transmitter and the receiver.

18. The apparatus according to claim 15, wherein the reception controller is configured to detect a loss of one or more of the control packets, and to take a corrective action that prevents the loss of the control packets from affecting detection of the mismatch.

19. The apparatus according to claim 18, wherein the transmission controller is configured to add to the control packets respective sequence numbers, and wherein the reception controller is configured to detect the loss of the control packets by detecting a gap in the sequence numbers of the received control packets.

20. The apparatus according to claim 18, wherein the reception controller is configured to detect the loss of the control packets by detecting that no control packet is received in a predefined time window around an expected control packet arrival time.

21. The apparatus according to claim 18, wherein the corrective action comprises discarding the measured mismatch for at least two time intervals.

22. The apparatus according to claim 18, wherein the corrective action comprises delaying a notification of the loss by at least two time intervals.

23. A communication system, comprising:
a transmitter, which is configured to generate a sequence of data packets, to insert control packets into the sequence, such that a given control packet is indicative of a count of the data packets that are transmitted in a time interval that ends with a previous control packet that precedes the given control packet, and to transmit the sequence, including the data packets and the inserted control packets; and
a receiver, which is configured to receive the sequence from the transmitter, and to measure a mismatch in packet count between the transmitter and the receiver using the control packets.
